(19) United States
(12) Patent Application Publication
(10) Pub. No.: US 2025/0034024 A1
(43) Pub. Date: Jan. 30, 2025

(54) METHOD FOR MANUFACTURING OPTICAL FIBER

(71) Applicant: SUMITOMO ELECTRIC INDUSTRIES, LTD., Osaka (JP)

(72) Inventors: Takahito ENDO, Utsunomiya-shi (JP); Manabu SHIOZAKI, Osaka (JP); Shuhei TOYOKAWA, Osaka (JP); Kazuhiro YONEZAWA, Utsunomiya-shi (JP); Yuuji IZUMI, Utsunomiya-shi (JP); Maoto NOZEKI, Utsunomiya-shi (JP)

(21) Appl. No.: 18/780,966

(22) Filed: Jul. 23, 2024

(30) Foreign Application Priority Data
Jul. 24, 2023 (JP) 2023-120071

(51) Int. Cl. C03B 37/014

(52) U.S. Cl. CPC C03B 37/0146

(57) ABSTRACT

An embodiment of the present disclosure provides a method for manufacturing an optical fiber in which an optical fiber is manufactured using a drawing furnace including a carbon furnace tube. The method includes drawing the optical fiber while supplying gas having an oxygen concentration of 3 ppm or more and 20 ppm or less as a major component of inert gas into the furnace tube.

### CROSS-REFERENCE TO RELATED APPLICATION

This application claims priority from Japanese Patent Application No. 2023-120071, filed on Jul. 24, 2023, the entire subject matter of which is incorporated herein by reference.

### TECHNICAL FIELD

The present disclosure relates to a method for manufacturing an optical fiber.

### BACKGROUND

JP2012-148924A discloses that a glass preform is heated and drawn into an optical fiber in a gas atmosphere of inert gas. In addition, JP2012-148924A discloses a sealing mechanism that seals a gap between an upper end opening of a drawing furnace and a glass preform with sealing gas. A gas flow rate of the sealing gas is controlled such that an oxygen concentration is 50 ppm or less.

JPS60-122743A discloses that a glass preform is heated and drawn into an optical fiber in a gas atmosphere where oxygen gas and fluorine gas are mixed with inert gas.

Helium (He) and Handling Industrial Gases, Iwatani Corporation, Industrial Gas Comprehensive Site, [online], [Searched on Apr. 20, 2023], The Internet “https://industry.iwatani.co.jp/industrial-gas/lineup/359/” discloses high-purity helium gas having an oxygen concentration of 3 ppm or less.

### SUMMARY

Incidentally, carbon is mainly used as a material of a furnace tube of a drawing furnace.

In order to prevent oxidation of the carbon, high-purity inert gas not including oxygen is used as gas to be supplied into the furnace tube. However, the high-purity inert gas is expensive.

An object of the present disclosure is to provide a method for manufacturing an optical fiber capable of suppressing deterioration of a furnace tube and breakage of an optical fiber.

An embodiment of the present disclosure provides a method for manufacturing an optical fiber in which an optical fiber is manufactured using a drawing furnace including a carbon furnace tube, the method including:

drawing the optical fiber while supplying gas having an oxygen concentration of 3 ppm or more and 20 ppm or less as a major component of inert gas into the furnace tube.

According to the present disclosure, a method for manufacturing an optical fiber capable of suppressing deterioration of a furnace tube and breakage of an optical fiber can be provided.

### BRIEF DESCRIPTION OF DRAWINGS

FIG. 1 is a diagram illustrating a configuration of a device for manufacturing an optical fiber according to an embodiment.

FIG. 2 is a graph illustrating a relationship between an oxygen concentration in gas supplied into a furnace tube and a breakage rate of an optical fiber.

FIG. 3 is a graph illustrating a relationship between the oxygen concentration in the gas supplied into the furnace tube and the lifetime of the furnace tube.

FIG. 4 is a graph of a simulation result illustrating a relationship between an internal temperature of the furnace tube and an oxygen concentration produced from an optical fiber preform.

### DESCRIPTION OF EMBODIMENTS

### Description of Embodiment of Present Disclosure

First, the content of an embodiment of the present disclosure will be described.

(1) A method for manufacturing an optical fiber according to the present disclosure is
a method for manufacturing an optical fiber in which an optical fiber is manufactured using a drawing furnace including a carbon furnace tube, the method including:
drawing the optical fiber while supplying gas having an oxygen concentration of 3 ppm or more and 20 ppm or less as a major component of inert gas into the furnace tube.

In the above-described method, the oxygen concentration of the gas supplied into the furnace tube is 3 ppm or more. Therefore, a breakage frequency of the optical fiber is reduced. On the other hand, the oxygen concentration of the gas supplied into the furnace tube is 20 ppm or less. Therefore, deterioration of the furnace tube caused by oxidation can be further suppressed.

(2) In the method for manufacturing an optical fiber according to (1), the gas may have an oxygen concentration of 5 ppm or more.

In the above-described method, the breakage frequency of the optical fiber is further reduced.

(3) In the method for manufacturing an optical fiber according to (1) or (2), the gas may have an oxygen concentration of 10 ppm or less.

In the above-described method, the breakage frequency of the optical fiber can be further reduced, and deterioration of the furnace tube caused by oxidation can be further suppressed.

(4) In the method for manufacturing an optical fiber according to any one of (1) to (3), the gas supplied into the furnace tube may be recovered, the recovered gas may be purified, and the purified gas may be supplied into the furnace tube.

In the above-described method, a manufacturing cost can be further reduced by reusing the gas.

(5) In the method for manufacturing an optical fiber according to any one of (1) to (4), the inert gas may be helium gas.

In the above-described method, helium gas is expensive, and thus an effect of reducing the manufacturing cost increases.

(6) In the method for manufacturing an optical fiber according to any one of (1) to (5), an internal temperature of the furnace tube may be 2200° C. or lower.

In the above-described method, by setting the internal temperature of the furnace tube to be 2200° C. or lower, volatilization of silica glass can be further suppressed, and deterioration of the furnace tube can be suppressed.

### Details of Embodiment of Present Disclosure

A specific example of a method for manufacturing an optical fiber according to an embodiment of the present disclosure will be described below with reference to the drawings.

The present invention is not limited to these examples and is intended to include any modifications within the scope and meaning equivalent to the terms of the claims. In addition, in each of the drawings used for the following description, the reduced scale may be appropriately changed such that each of members has a recognizable size.

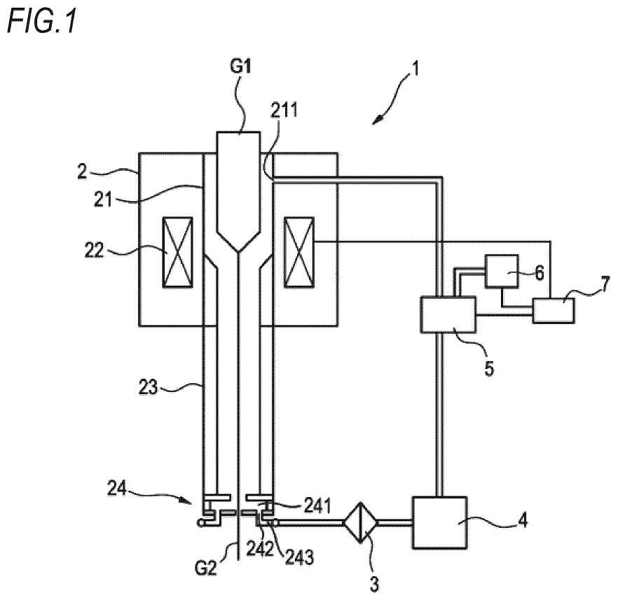

FIG. 1 illustrates a part of a device 1 for manufacturing an optical fiber. The device 1 for manufacturing an optical fiber manufactures an optical fiber G2 by heating and drawing an optical fiber preform G1 into the optical fiber G2. As illustrated in FIG. 1, the device 1 for manufacturing an optical fiber includes a drawing furnace 2. The drawing furnace 2 includes a furnace tube 21, a heater 22, an extension tube 23, and a gas recovery mechanism 24.

The furnace tube 21 is disposed in a center portion of the drawing furnace 2. As the furnace tube 21, a carbon furnace tube is used. That is, the furnace tube 21 is formed of a material including carbon as a major component. In the furnace tube 21, for example, the optical fiber preform G1 formed of silica glass (SiO₂) as a major component is held by a preform hanging mechanism (not illustrated).

In the furnace tube 21, a gas supply port 211 is provided. Gas is supplied from the gas supply port 211 into the furnace tube 21. As the gas to be supplied into the furnace tube 21, gas including inert gas as a major component and including a predetermined concentration of oxygen is used. Specifically, gas including the inert gas as a major component and having an oxygen concentration of 3 ppm or more and 20 ppm or less and preferably 5 ppm or more and 10 ppm or less is used. As the inert gas, for example, helium (He) gas, argon (Ar) gas, or nitrogen (N₂) gas is used.

The heater 22 is disposed to surround the furnace tube 21. The heater 22 is configured to heat the furnace tube 21. By heating the furnace tube 21, the optical fiber preform G1 disposed in the furnace tube 21 is heated.

The extension tube 23 is provided below the furnace tube 21 to be continuous to the furnace tube 21. The optical fiber G2 drawn by the furnace tube 21 continuously passes through the extension tube 23. The extension tube 23 may be formed to be integrated with the furnace tube 21 or may be provided to be attachable to or detachable from the furnace tube 21.

The gas recovery mechanism 24 is a mechanism for recovering the gas supplied into the drawing furnace 2. The gas recovery mechanism 24 includes a gas recovery chamber 241, a gas recovery port 242, and a gas suction tube 243.

The gas recovery chamber 241 is provided below the extension tube 23. The gas recovery chamber 241 may be provided to be continuous to the extension tube 23 or may be provided to be attachable to or detachable from the extension tube 23.

The gas recovery port 242 is provided in the gas recovery chamber 241. In the present example, a plurality of gas recovery ports 242 are provided in a bottom surface of the gas recovery chamber 241. The gas recovery port 242 may be provided in a peripheral wall of the gas recovery chamber 241.

The gas suction tube 243 is connected to the gas recovery port 242. In the present example, the gas suction tube 243 is connected to each of the plurality of gas recovery ports 242, and each of the gas suction tubes 243 communicates with the annular suction tube. The gas recovered in the gas recovery chamber 241 is sucked from the gas recovery port 242 to the outside through the gas suction tube 243.

The device 1 for manufacturing an optical fiber further includes a filter 3, a gas purification device 4, a gas supplier 5, and a gas replenishment device 6. The gas sucked by the gas suction tube 243 is supplied to the filter 3. In the filter 3, solid matter or the like is removed from the sucked gas.

The gas purification device 4 separates and purifies the gas including the inert gas as a major component and including oxygen from the gas recovered from the drawing furnace 2 and filtered through the filter 3. The gas purified by the gas purification device 4 is supplied to the gas supplier 5. The gas supplied to the gas supplier 5 is supplied into the furnace tube 21 from the gas supply port 211 of the furnace tube 21.

The gas replenishment device 6 is connected to the gas supplier 5 and replenishes the inert gas from the gas replenishment device 6 to the gas supplier 5 as necessary. For example, when the amount of the gas purified by the gas purification device 4 is less than the amount of the gas supplied into the furnace tube 21, the inert gas including oxygen is replenished from the gas replenishment device 6. The gas that is supplied to the gas supplier 5 and is replenished with the inert gas is supplied from the gas supply port 211 of the furnace tube 21.

The device 1 for manufacturing an optical fiber includes a controller 7. The controller 7 controls operations of the heater 22, the gas supplier 5, the gas replenishment device 6, and the like. The controller 7 consists of a processor and a memory and stores a program or data for controlling each of the operations in the memory. For example, the controller 7 controls a flow rate at which the gas is supplied from the gas supplier 5 into the furnace tube 21 or a flow rate at which the inert gas is replenished from the gas replenishment device 6 to the gas supplier 5. In addition, the controller 7 controls a heating temperature of the heater 22 to control an internal temperature of the furnace tube 21. For example, the controller 7 controls the heater 22 such that the internal temperature of the furnace tube 21 becomes 2200° C. or lower.

Next, a method for manufacturing an optical fiber using the device 1 for manufacturing an optical fiber will be described.

First, the optical fiber preform G1 is inserted into the furnace tube 21 of the drawing furnace 2, and the lower portion of the optical fiber preform G1 is heated and melted by the heater 22. The molten optical fiber preform G1 is continuously drawn into the optical fiber G2 having a predetermined outer diameter due to the weight of the molten glass and a tensile strength.

The optical fiber G2 drawn in the furnace tube 21 passes through the inside of the extension tube 23 and is inserted into the gas recovery mechanism 24. The optical fiber G2 that has just been drawn in the furnace tube 21 is heated and softened. However, after the optical fiber G2 passes through the inside of the extension tube 23, quenching is relieved, and the optical fiber G2 is cooled and cured to some extent such that a variation in outer diameter is suppressed.

During the drawing of the optical fiber G2, the gas including the inert gas as a major component and including a predetermined concentration of oxygen is supplied into the furnace tube 21 through the gas supply port 211. The gas is supplied to uniformly fill a space in the furnace tube 21 and a space in the extension tube 23. Since the gas is supplied into the furnace tube 21, a variation in outer diameter of the optical fiber G2 caused by thermal fluctuation in the vicinity of the lower end portion of the optical fiber preform G1 melted in a neck-down shape is suppressed.

In addition, the gas supplied into the furnace tube 21 is recovered by the gas recovery mechanism 24. Specifically, the gas recovered by the gas recovery chamber 241 is sucked from the gas recovery port 242 by the gas suction tube 243. The gas sucked from the gas recovery port 242 passes through the filter 3 such that solid matter such as foreign particles in the gas is removed, and is sent to the gas purification device 4. In the gas purification device 4, the gas including the inert gas as a major component and including oxygen and another gas are separated and purified. The purified gas including the inert gas as a major component and including oxygen is supplied to the gas supplier 5 for reuse. Further, as necessary, the inert gas or the inert gas including oxygen is replenished from the gas replenishment device 6 to the gas supplier 5. The gas supplied to the gas supplier 5 or the gas replenished with the inert gas or the inert gas including oxygen is supplied from the gas supplier 5 to the furnace tube 21 through the gas supply port 211.

The drawn optical fiber G2 is inserted into the gas recovery mechanism 24, and is wound around a drum or the like through a cooling step using a cooling device (not illustrated) or a resin coating step using a coating device.

Here, the internal temperature of the drawing furnace 2 at which the optical fiber preform G1 is heated and melted to be drawn into the optical fiber G2 is very high. Therefore, carbon having excellent heat resistance is used for the furnace tube 21. This carbon is oxidized and consumed in an atmosphere including oxygen. Accordingly, in order to suppress deterioration of the carbon furnace tube 21 caused by oxidation, it is considered to use high-purity inert gas not including oxygen as the gas to be supplied into the furnace tube 21. However, the high-purity inert gas is expensive.

The present inventors found that, even when low-purity inert gas is used, by setting the oxygen concentration in the inert gas to be supplied into the furnace tube 21 formed of carbon to be the appropriate range, deterioration of the furnace tube 21 can be suppressed, and volatilization of silica glass can be further suppressed as compared to a case where high-purity inert gas is supplied.

Specifically, in the method for manufacturing an optical fiber according to the present embodiment, gas including inert gas as a major component and having an oxygen concentration of 3 ppm or more is supplied to the furnace tube 21. As a result, volatilization of silica glass from the optical fiber preform G1 or the optical fiber G2 can be suppressed. As a result, a breakage frequency of the drawn optical fiber G2 is reduced. When the oxygen concentration in the gas is 5 ppm or more, the breakage frequency of the optical fiber G2 is further reduced.

On the other hand, when the oxygen concentration in the gas to be supplied to the furnace tube 21 exceeds 20 ppm, deterioration of the furnace tube 21 caused by oxidation is promoted. Specifically, in the method for manufacturing an optical fiber according to the present embodiment, gas including inert gas as a major component and having an oxygen concentration of 20 ppm or less is supplied to the furnace tube 21. As a result, deterioration of the furnace tube 21 caused by oxidation can be suppressed. Further, when the oxygen concentration in the gas is 10 ppm or less, The breakage frequency of the optical fiber G2 can be further reduced, and the deterioration of the furnace tube 21 caused by oxidation can be further suppressed.

In addition, the gas including oxygen is used as the gas to be supplied into the furnace tube 21. Therefore, the manufacturing cost can be reduced as compared to a case where high-purity inert gas is used. In particular, high-purity helium gas is expensive. Therefore, when gas including helium gas as a major component is used, the effect of reducing the manufacturing cost increases.

In addition, in the present embodiment, the gas supplied into the furnace tube 21 is recovered by the gas recovery mechanism 24 and reused. Therefore, the manufacturing cost can be further reduced.

In addition, in the present embodiment, the internal temperature of the furnace tube 21 of the drawing furnace 2 is controlled to be 2200° C. or lower. Therefore, volatilization of silica glass from the optical fiber preform G1 can be further suppressed. Specifically, as the internal temperature of the furnace tube 21 of the drawing furnace 2 increases, a large amount of oxygen is produced from the optical fiber preform G1. Accordingly, by setting the internal temperature of the furnace tube 21 to be 2200° C. or less, the production of oxygen from the optical fiber preform G1 can be suppressed. Therefore, deterioration of the furnace tube 21 can be suppressed.

### EXAMPLES

Hereinafter, the present disclosure will be described in more detail using Examples according to the present disclosure. The present disclosure is not limited to the following Examples.

When the optical fiber G2 was manufactured using the device 1 for manufacturing an optical fiber, the oxygen concentration in the gas supplied into the furnace tube 21 was measured, and a relationship between a breakage rate of the optical fiber G2 and the lifetime of the furnace tube 21 was obtained. As the gas supplied into the furnace tube 21, gas including helium gas that was inert gas as a major component and having an oxygen concentration of 1 ppm to 25 ppm was used.

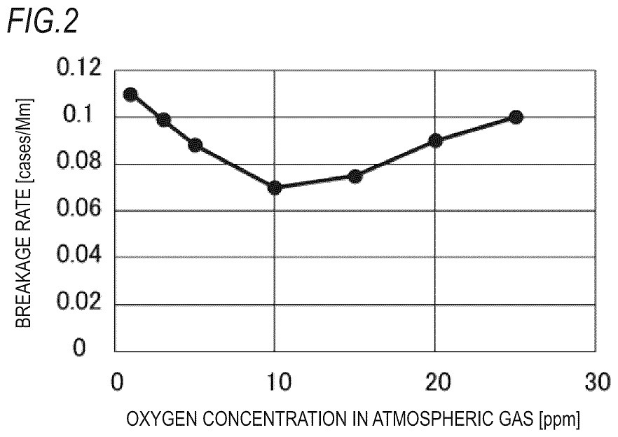

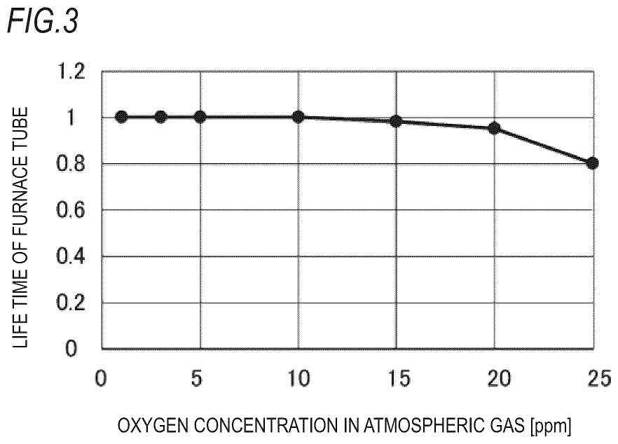

FIG. 2 illustrates a relationship between the oxygen concentration [ppm] in the gas supplied into the furnace tube 21 and the breakage rate [cases/Mm] of the optical fiber G2. FIG. 3 illustrates a relationship between the oxygen concentration [ppm] in the gas supplied into the furnace tube 21 and the lifetime of the furnace tube 21. A period of time taken until a decrease in weight of the furnace tube 21 caused by the use reached a predetermined amount was obtained as the lifetime, and the lifetime of the furnace tube 21 when gas having an oxygen concentration of 1 ppm or less was supplied was set as 1. In addition, Table 1 shows a relationship between the oxygen concentration in the gas supplied into the furnace tube 21, the breakage rate of the optical fiber G2, and the lifetime of the furnace tube 21 based on the results of FIGS. 2 and 3.

TABLE 1

| Oxygen | Breakage | Lifetime of |
|---|---|---|
| Concentration [ppm] | Rate [cases/Mm] | Furnace Tube |
| 1 | 0.11 | 1 |
| 3 | 0.099 | 1 |
| 5 | 0.088 | 1 |
| 10 | 0.07 | 1 |
| 15 | 0.075 | 0.98 |
| 20 | 0.09 | 0.95 |
| 25 | 0.1 | 0.8 |

As shown in FIG. 2 and Table 1, until the oxygen concentration reached 10 ppm, as the oxygen concentration increased, the breakage rate of the optical fiber decreased. While the oxygen concentration was in a range of 15 ppm to 25 ppm, the breakage rate of the optical fiber increased along with the oxygen concentration but was lower than the breakage rate when the oxygen concentration was 1 ppm or less. In addition, while the oxygen concentration was in a range of 3 ppm or more and 20 ppm or less, the breakage rate of the optical fiber was lower than 0.1.

As shown in FIG. 3 and Table 1, the lifetime of the furnace tube 21 did not substantially change until the oxygen concentration of 20 ppm, but significantly decreased at the oxygen concentration of 25 ppm.

It was found from the above results that, by using gas including helium gas as a major component and having an oxygen concentration of 3 ppm or more and 20 ppm or less as the gas to be supplied into the furnace tube 21, the breakage frequency of the optical fiber G2 decreases, and the effect on the lifetime of the furnace tube 21 does not substantially change as compared to a case where the oxygen concentration is 1 ppm or less. In addition, it was found that, by using gas including helium gas as a major component and having an oxygen concentration of 5 ppm or more, the breakage frequency of the optical fiber G2 further decreases. In addition, it was found that, by using gas including helium gas as a major component and having an oxygen concentration of 10 ppm or less, the breakage frequency of the optical fiber is low and the lifetime of the furnace tube 21 does not substantially change as compared to a case where the oxygen concentration is 1 ppm or less.

In the above results, helium gas was used as the inert gas. However, even when inert gas (for example, argon gas or nitrogen gas) other than helium is used, the same results can be obtained. The reason for this is presumed as follows. Even when the inert gas other than helium is used, by setting the oxygen concentration in the inert gas to be the appropriate range, as in the case where helium gas is used as the inert gas, deterioration of the furnace tube 21 can be suppressed, and volatilization of silica glass from the optical fiber preform G1 or the optical fiber G2 can be suppressed.

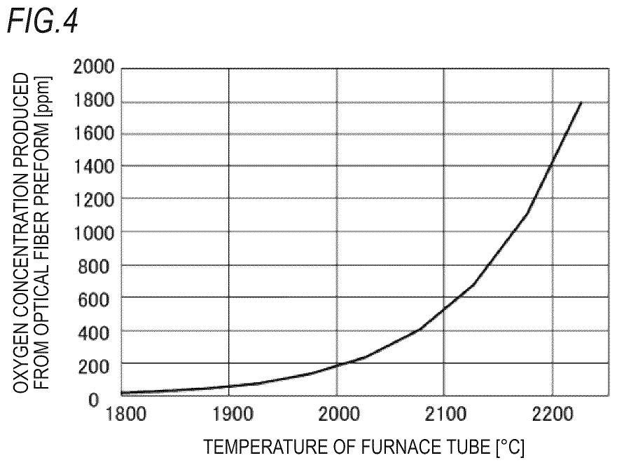

Next, when the optical fiber G2 was manufactured using the device 1 for manufacturing an optical fiber, a relationship between the internal temperature of the furnace tube 21 and the oxygen concentration produced from the optical fiber preform G1 in the furnace tube 21 was simulated. FIG. 4 illustrates the simulation result. In this simulation, chemical equilibrium computation was performed using general-purpose thermodynamic analysis software.

As illustrated in FIG. 4, the oxygen concentration produced from the optical fiber preform G1 exponentially increases from when the internal temperature of the furnace tube 21 is about 2000° C. When the internal temperature of the furnace tube 21 is 2200° C. or lower, the oxygen concentration produced from the optical fiber preform G1 is 1500 ppm or less. By setting the internal temperature of the furnace tube 21 to be 2200° C. or lower, the concentration of oxygen produced by volatilization of silica glass can be suppressed, and the lifetime of the furnace tube 21 can be further increased. In FIG. 4 the oxygen concentration represents the total concentration of O, O₂, and O₃.

Although the present invention has been described in detail with reference to specific embodiments, it will be apparent to those skilled in the art that various changes and modifications can be made without departing from the spirit and scope of the invention. In addition, the numbers, positions, shapes, and the like of the components described above are not limited to those of the embodiments and can be changed to numbers, positions, shapes, and the like suitable for implementing the present invention.

In the above-described embodiment, by setting the oxygen concentration to be in the appropriate range in the manufacturing step of an optical fiber, breakage of the optical fiber G2 and an deterioration of the furnace tube 21 are suppressed. However, the present disclosure is also be applicable to, for example, a manufacturing step of an optical fiber preform where a sintering furnace including a quartz furnace tube is used. That is, by setting the oxygen concentration in the inert gas such as helium to be supplied into the quartz furnace tube to be the appropriate range, volatilization of silica glass from the optical fiber preform or the furnace tube can be suppressed. As a result, deterioration of the quartz furnace tube can be suppressed, and deposition of volatilized silica glass on a downstream exhaust port of the furnace tube can be suppressed.

What is claimed is:

1. A method for manufacturing an optical fiber in which an optical fiber is manufactured using a drawing furnace including a carbon furnace tube, the method comprising:
drawing the optical fiber while supplying gas having an oxygen concentration of 3 ppm or more and 20 ppm or less as a major component of inert gas into the furnace tube.

2. The method for manufacturing an optical fiber according to claim 1,
wherein the gas has an oxygen concentration of 5 ppm or more.

3. The method for manufacturing an optical fiber according to claim 1,
wherein the gas has an oxygen concentration of 10 ppm or less.

4. The method for manufacturing an optical fiber according to claim 1,
wherein the gas supplied into the furnace tube is recovered, the recovered gas is purified, and the purified gas is supplied into the furnace tube.

5. The method for manufacturing an optical fiber according to claim 1,
wherein the inert gas is helium gas.

6. The method for manufacturing an optical fiber according to claim 1,
wherein an internal temperature of the furnace tube is 2200° C. or lower.
